(19) United States
(12) Patent Application Publication
(10) Pub. No.: US 2010/0054507 A1
(43) Pub. Date: Mar. 4, 2010

(54) FILM SPEAKER

(76) Inventors: Sang Keun Oh, Gyeonggi-do (KR); Kyoung Hwa Song, Seoul (KR); June Ki Park, Gyeonggi-do (KR); Da Jeong Jeong, Gyeonggi-do (KR); Dong Soo Lee, Gyeonggi-do (KR); Sang Gue Lim, Gyeonggi-do (KR); In Suk Park, Gyeonggi-do (KR)

Correspondence Address: KED & ASSOCIATES, LLP, P.O. Box 221200, Chantilly, VA, 20153-1200, US

(21) Appl. No.: 12/523,115

(22) PCT Filed: Jan. 24, 2008
(86) PCT No.: PCT/KR08/00445

§ 371 Date: Jul. 14, 2009

(30) Foreign Application Priority Data
Mar. 15, 2007 (KR) 10-2007-0025543

(51) Int. Cl. H04R 25/00

(52) U.S. Cl. 381/190

(57) ABSTRACT

A film speaker is provided. The film speaker includes: a piezoelectric film oscillating by receiving a voltage corresponding to a sound signal from a sound signal supply unit; a plurality of carbon nanotube films formed on both sides of the piezoelectric film; and a plurality of electrodes connected to the plurality of carbon nanotube films, receiving the voltage corresponding to the sound signal from the sound signal supply unit, and applying the voltage to the plurality of carbon nanotube films.

### TECHNICAL FIELD

The present invention relates to a film speaker, and more particularly, to a film speaker using a carbon nanotube (CNT).

### BACKGROUND ART

A speaker is an equipment which converts an electrical signal into oscillation of air which human ears can hear. Recently, with miniaturization and thinning of various electronic devices such as a mobile electronic device, a film speaker has been developed. The film speaker reproduces sounds using a reverse piezoelectric effect of generating mechanical oscillation using an electrical signal.

Generally, a film speaker includes a piezoelectric film which mechanically oscillates when an alternating current (AC) voltage is applied thereto, a plurality of conductive polymer films which are formed on both sides of the piezoelectric film, and a plurality of electrodes which transfer an AC voltage supplied from an external power supply to the conductive polymer films. When an AC voltage corresponding to a sound signal is applied to the electrodes, a voltage difference is generated between the conductive polymer films to oscillate the piezoelectric film and thus reproduce sounds.

As described above, in the film speaker according to the conventional technique, the conductive polymer films are formed on both sides of the piezoelectric film. Since conductive polymer forming the conductive polymer films has high conductivity and is flexible and light-weight, the conductive polymer is used in various industries.

### DISCLOSURE OF INVENTION

### Technical Problem

However, such a conductive polymer has limited conductivity, is not easily coated on a piezoelectric film, and also is not uniformly applied on the piezoelectric film. Accordingly, the thicknesses of the conductive polymer films become non-uniform, which makes sound pressure non-uniform and deteriorates the quality of sound. Also, since conductive polymer has poor chemical resistance and poor moisture resistance, it has a poor sound pressure characteristic in a low tone region lower than 400 Hz.

Meanwhile, the conductive polymer films can be made of Indium Tin Oxide (ITO), instead of conductive polymer. However, if an ITO film is used in a film speaker, the ITO layer can be easily broken by mechanical oscillation of the film speaker.

### Technical Solution

The present invention provides a film speaker which is capable of improving a sound pressure characteristic, obtaining an excellent quality of sound even in a low tone region lower than 400 Hz, and guaranteeing a semipermanent life and high light transmission, by supplying a voltage to a piezoelectric film using a carbon nanotube.

### Advantageous Effects

According to the present invention, the following effects are obtained.

First, since a carbon nanotube film can be easily coated on a piezoelectric film and its thickness can be adjusted in units of nanometer so that the carbon nanotube film can be formed in a predetermined thickness, a voltage can be supplied uniformly over the entire surface of the piezoelectric film. Accordingly, it is possible to make sound pressure uniform and guarantee the quality of sound.

Second, since the carbon nanotube film has excellent chemical resistance and moisture resistance compared to a conductive polymer, the carbon nanotube film has a semipermanent life.

Third, since the carbon nanotube film has excellent light transmission, it can be used in electronic devices requiring high light transmission.

Fourth, since the carbon nanotube film has an excellent bending characteristic compared to an ITO film and thus no crack occurs when the carbon nanotube film is wrapped or bended, the carbon nanotube film can be used in flexible electronic devices.

Fifth, the carbon nanotube film can obtain the quality of sound which is more excellent than that of a polymer film, even in a low tone region lower than 400 Hz.

Sixth, the carbon nanotube film can obtain higher sound pressure at the same voltage than a conductive polymer film.

Seventh, the carbon nanotube film requires a lower driving voltage to obtain the same sound pressure than the conductive polymer film, and thus has low power consumption compared to a polymer film.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a film speaker according to an embodiment of the present invention;

FIG. 2 is an exploded perspective view of the film speaker illustrated in FIG. 1;

FIG. 3 is a cross-sectional view taken along a line A-A′ of FIG. 1; and

FIGS. 4 and 5 are graphs showing sound pressure characteristics with respect to resistance values and frequencies, in a carbon nanotube film according to an embodiment of the present invention and a polymer film according to a comparative example.

### BEST MODE FOR CARRYING OUT THE INVENTION

According to an aspect of the present invention, there is provided a film speaker including: a piezoelectric film oscillating by receiving a voltage corresponding to a sound signal from a sound signal supply unit; and a plurality of carbon nanotube films formed on both sides of the piezoelectric film; and a plurality of electrodes connected to the plurality of carbon nanotube films, receiving the voltage corresponding to the sound signal from the sound signal supply unit, and applying the voltage to the plurality of carbon nanotube films.

Additional features of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### Mode for the Invention

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

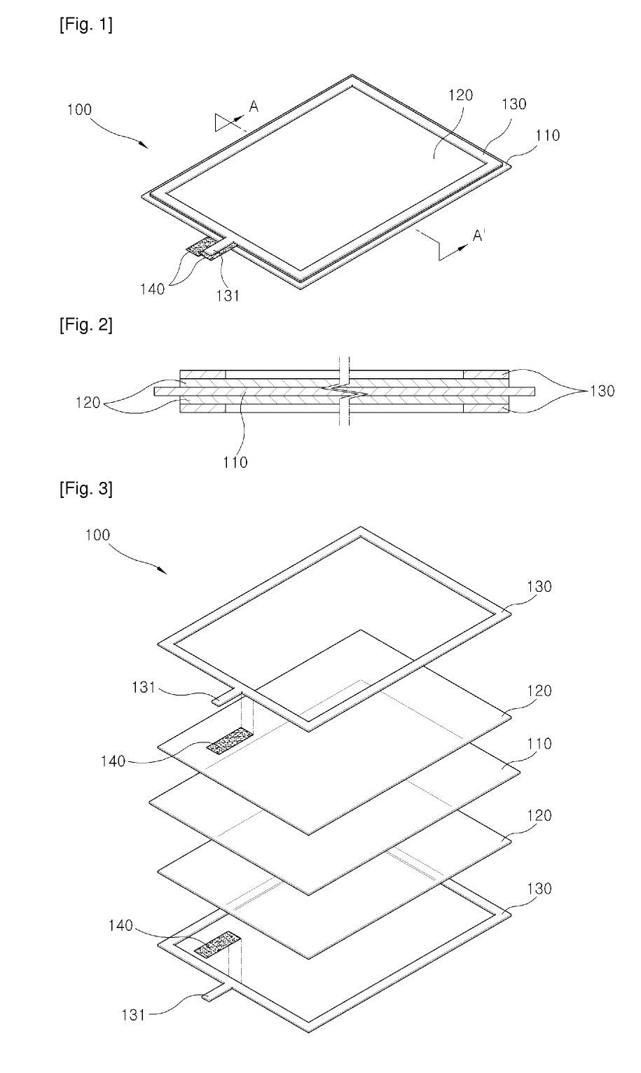

FIG. 1 is a perspective view of a film speaker according to an embodiment of the present invention. FIG. 2 is an exploded perspective view of the film speaker illustrated in FIG. 1. FIG. 3 is a cross-sectional view taken along a line A-A′ of FIG. 1.

Referring to FIGS. 1, 2, and 3, the film speaker 100 includes a piezoelectric film 110, a plurality of carbon nanotube (CNT) films 120, and a plurality of electrodes 130.

The piezoelectric film 110 mechanically oscillates by a reverse piezoelectric effect to reproduce sounds, when an electrical signal, that is, a voltage corresponding to a sound signal is applied thereto. The reverse piezoelectric effect means a phenomenon, by which a crystalline plate having piezoelectricity expands and contracts periodically when a high frequency voltage is applied to the crystalline plate, and resonates and strongly oscillates particularly when the frequency of the high frequency voltage is tuned to a natural frequency of the crystalline plate. The piezoelectric film 110 may be made of polyvinylidene fluoride, but can be made of various materials other than polyvinylidene fluoride.

The carbon nanotube films 120 are respectively formed on both sides of the piezoelectric film 110. That is, one of the carbon nanotube films 120 is formed with a predetermined thickness on one side of the piezoelectric film 110, and the other of the carbon nanotube films 120 is formed with a predetermined thickness on the other side of the piezoelectric film 110.

The carbon nanotube films 120 may be formed on the center portions of both surfaces of the piezoelectric film 110, and not formed on the edge portions of the both surfaces of the piezoelectric film 110. That is, the carbon nanotube films 120 are respectively formed on the center portions of both surfaces of the piezoelectric film 110, which are separated by a predetermined distance from the edges of the piezoelectric film 110. This is aimed at preventing a voltage from being supplied to the edge portions, on which no carbon nanotube film is formed, of the piezoelectric film 110 so that the edge portions of the piezoelectric film 110 do not oscillate, when a voltage is supplied to the center portions, on which the carbon nanotube films are formed, of the piezoelectric film 110 to oscillate the piezoelectric film 110. Accordingly, since the edge portions of the piezoelectric film 110 do not oscillate, it is possible to prevent sounds from being broken at the edge portions of the piezoelectric film 110.

The carbon nanotube films 120 are thin films which are made of a carbon nanotube, and each carbon nanotube film 120 can be formed by any one of a spraying method, a decompression filter method, a spin coating method, an electrophoresis deposition method, a casting method, an inkjet printing method, and an offset printing method. That is, the carbon nanotube films 120 can be formed with a carbon nanotube solution in which a carbon nanotube is mixed with a solvent, using any one of the above-mentioned methods.

The carbon nanotube solution is prepared by mixing 0.01 through 30 wt % of a carbon nanotube, 70 through 99.99 wt % of a solvent, and 0.01 through 20 wt % of a dispersing agent. The carbon nanotube may be any one of single-walled, dual-walled, multi-walled, and rope carbon nanotubes. Here, the carbon nanotube may be provided in the form of powders, and diluted with the solvent.

The solvent may be any one of water, methyl alcohol, ethyl alcohol, isopropyl alcohol, normal butanol, Toluene, Xylene, 1-metyl-2-pyrrolidon, chloroform, etyle acetate, 2-methoxyethanol, ethylene glycol, polyethylene glycol, and dimethyl sulfoxide. The solvent may be a mixture in which one or more of the above-mentioned solvents are mixed.

A dispersing agent is used to disperse in the solvent the carbon nanotube which is prepared in the form of powders. In the current embodiment, the dispersing agent may be any one of a sodium dodecy sulfate (SDS) dispersing agent, a triton X dispersing agent, and a lithium dodecy sulfate (LDS) dispersing agent. However, the dispersing agent is not limited to one of the above-mentioned agents, and may be any other dispersing agent. Also, a mixture in which two or more of the above-mentioned dispersing agents are mixed can be used as the dispersing agent.

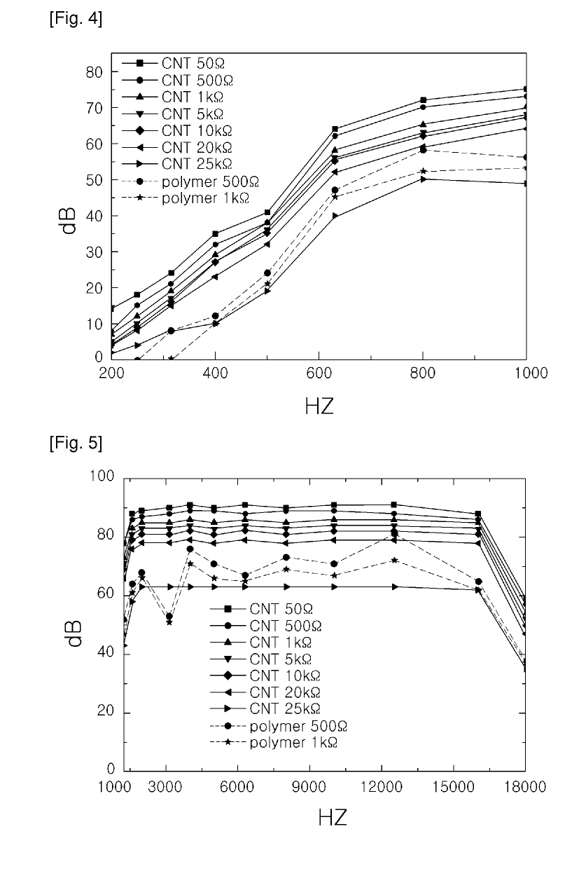

As described above, the carbon nanotube film 120 can be coated with the carbon nanotube solution by various methods. By adjusting the coating thickness and density of the carbon nanotube solution, the resistance value of the carbon nanotube film 120 can be changed. For example, the carbon nanotube film 120 has a resistance value from 50 Ω/sq to 20 kΩ/sq. In order to obtain an excellent output characteristic in a low frequency region lower than 400 Hz, the carbon nanotube film 120 has a resistance value from 50 Ω/sq to 200 Ω/sq, as will be described later with reference to FIG. 4.

Since the carbon nanotube film 120 can be easily coated on a piezoelectric film and the thickness of the carbon nanotube film 120 can be adjusted in units of nanometer, the carbon nanotube film 120 can be formed in a predetermined thickness. Accordingly, a voltage can be uniformly supplied to the piezoelectric film 110 by the carbon nanotube film 120. As a result, it is possible to make sound pressure uniform and guarantee the quality of sound.

Also, since the carbon nanotube constructing the carbon nanotube film 120 has excellent chemical resistance and moisture resistance compared to a conductive polymer, the carbon nanotube film 120 has a semipermanent life. Also, since the carbon nanotube film 120 has an excellent bending characteristic compared to an ITO film, no crack occurs when the carbon nanotube film 120 is wrapped or bended, so that the carbon nanotube film 120 can be adopted in flexible electronic devices. Furthermore, since the carbon nanotube film 120 has high conductivity compared to a conductive polymer film, the carbon nanotube film 120 can obtain higher sound pressure at the same voltage than a conductive polymer film. Also, since the carbon nanotube film 120 has a lower driving voltage for generating the same sound pressure than that of the conductive polymer film, the carbon nanotube film 120 has low power consumption.

The electrodes 130 receives a voltage (for example, an AC voltage) corresponding to a sound signal from a sound signal supply unit (not shown), and supplies the AC voltage to the carbon nanotube films 120. Accordingly, if an AC voltage corresponding to a sound signal is applied to the electrodes 130, a voltage difference is generated between the carbon nanotube films 120, and the piezoelectric film 110 which receives the AC voltage from the carbon nanotube films 120 oscillates and thus reproduces sounds.

The electrodes 130 are respectively connected to the carbon nanotube films 120 in such a manner that the electrodes 130 may be formed along the edges of the carbon nanotube films 120. The electrodes 130 may be formed by a method of printing metal-paste (for example, silver-paste) or conductive ink along the edges of the carbon nanotube films 120. Generally, a copper tape is used as electrodes of a film speaker, but contact resistance increases at contacts between such a copper tape and a conductive polymer film since the copper tape is not closely adhered to the conductive polymer film.

Since the electrodes 130 are closely adhered to the carbon nanotube films 120 if the electrodes 130 are formed in the above-described manner, contact resistance can be minimized at contacts between the electrodes 130 and the carbon nanotube films 120.

Terminals 131 may extend from the electrodes 130, respectively. The terminals 131 are protruded outside the carbon nanotube films 120 and electrically connected to the sound signal supply unit so that a voltage can be supplied to the electrodes 130. The terminals 131 may be disposed at the center or corner portions of the electrodes 130.

Reinforcing tapes 140 are respectively attached to one side of the terminals 131. The reinforcing tapes 140, which have insulating property, are disposed in a manner to face each other at between the terminals 131. Also, the reinforcing tapes 140 have sizes wider than those of the terminals 131. Therefore, the reinforcing tapes 140 make the terminals 131 insulated from each other, thereby preventing a short circuit between the terminals 131. Also, the reinforcing tapes 140 support the terminals 131 so that the shapes of the terminals 131 are not transformed.

A fact that the carbon nanotube film 120 included in the film speaker 100 according to the current embodiment of the present invention has an excellent sound pressure characteristic compared to the conductive polymer film will be understood by a graph shown in FIG. 4.

FIG. 4 is a graph showing a sound pressure characteristic with respect to resistance values and frequencies, in a frequency band of 200 Hz through 1 kHz, in the carbon nanotube film according to the present invention and the polymer film according to a comparative example. FIG. 5 is a graph showing a sound pressure characteristic with respect to resistance values and frequencies, in a frequency band of 1 kHz through 18 kHz, in the carbon nanotube film according to the present invention and the polymer film according to the comparative example. FIGS. 4 and 5 show sound pressure with respect to frequencies when the resistance values of the carbon nanotube film are 50 Ω/sq, 500 Ω/sq, 1 kΩ/sq, 5 kΩ/sq, 10 kΩ/sq, 20 kΩ/sq, and 25 kΩ/sq, and the resistance values of the polymer film are 500 Ω/sq and 1000 Ω/sq.

As illustrated in FIGS. 4 and 5, the carbon nanotube film whose resistance values are 500 Ω/sq and 1 kΩ/sq has a flat waveform of sound pressure higher by 20 dB or more, in the whole frequency region, than that of the polymer film whose resistance values are 500 Ω/sq and 1 kΩ/sq. This means that the carbon nanotube film can output the quality of sound which is more uniform than that of the polymer film. Furthermore, the carbon nanotube film can have a relatively low resistance value of 50 Ω/sq, and output a uniform quality of sound even when it has the resistance of 50 Ω/sq. Also, the carbon nanotube film whose resistance values are 5 kΩ/sq, 10 kΩ/sq, and 20 kΩ/sq has a uniform waveform of sound pressure, in the whole frequency region, like when it has the resistance values of 500 Ω/sq and 1 kΩ/sq. Accordingly, when the carbon nanotube film has an arbitrary resistance value from 50 Ω/sq through 20 kΩ/sq, the carbon nanotube film will be an excellent sound output characteristic enough to be adopted in a speaker. Preferably, when the carbon nanotube film has an arbitrary resistance value from 50 Ω/sq to 2 kΩ/sq, the carbon nanotube film will be an excellent sound output characteristic enough to be adopted in a speaker. As seen in FIGS. 4 and 5, if the resistance value of the carbon nanotube film exceeds 20 kΩ/sq (for example, 25 kΩ/□), its sound output characteristic deteriorates sharply.

Also, the carbon nanotube film outputs some degree of sound even in a frequency band lower than 400 Hz, while the polymer film outputs sound lower by 20 dB than that of the carbon nanotube film in a frequency band lower than 400 Hz. This means that the carbon nanotube film has a sound pressure characteristic which is more excellent than that of the polymer film in a low tone region lower than 400 Hz. That is, the polymer film does not guarantee the quality of sound in a low tone region lower than 400 Hz, but the carbon nanotube film guarantees an excellent quality of sound in the low tone region lower than 400 Hz.

Also, in the carbon nanotube film, sound pressure decreases as its resistance value increases, and sound pressure increases as the resistance value decreases, in the whole frequency band. That is, by adjusting the resistance value of the carbon nanotube film, an output characteristic suitable for the film speaker can be obtained. For example, it is assumed that, when sound pressure output from a speaker is about 72 dB, a user will feel that the sound quality is good enough. If the user wants to hear sound with sound pressure of about 72 dB in a frequency band of 800 Hz through 1000 Hz, he or she has only to adjust the resistance value to the carbon nanotube film within a range of 50 Ω/sq through 200 Ω/sq.

As described above, according to the present invention, the following effects are obtained.

First, since the carbon nanotube film can be easily coated on the piezoelectric film and its thickness can be adjusted in units of nanometer so that the carbon nanotube film can be formed in a predetermined thickness, a voltage can be supplied uniformly over the entire surface of the piezoelectric film. Accordingly, it is possible to make sound pressure uniform and guarantee the quality of sound.

Second, since the carbon nanotube film has excellent chemical resistance and moisture resistance compared to a conductive polymer, the carbon nanotube film has a semipermanent life.

Third, since the carbon nanotube film has excellent light transmission, it can be used in electronic devices requiring high light transmission.

Fourth, since the carbon nanotube film has an excellent bending characteristic compared to an ITO film and thus no crack occurs when the carbon nanotube film is wrapped or bended, the carbon nanotube film can be used in flexible electronic devices.

Fifth, the carbon nanotube film can obtain the quality of sound which is more excellent than that of a polymer film, even in a low tone region lower than 400 Hz.

Sixth, the carbon nanotube film can obtain higher sound pressure at the same voltage than a conductive polymer film.

Seventh, the carbon nanotube film requires a lower driving voltage to obtain the same sound pressure than the conductive polymer film, and thus has low power consumption compared to a polymer film.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

The present invention can be applied to various acoustic devices.

1. A film speaker comprising: a piezoelectric film oscillating by receiving a voltage corresponding to a sound signal from a sound signal supply unit; a plurality of carbon nanotube films formed on both sides of the piezoelectric film; and a plurality of electrodes connected to the plurality of carbon nanotube films, receiving the voltage corresponding to the sound signal from the sound signal supply unit, and applying the voltage to the plurality of carbon nanotube films.

2. The film speaker of claim 1, wherein the plurality of carbon nanotube films are formed on center portions of both sides of the piezoelectric film and are not formed on edge portions of the both surfaces of the piezoelectric film, and the plurality of electrodes are respectively formed along the edge portions of the both sides of the plurality of carbon nanotube films.

3. The film speaker of claim 1, wherein the piezoelectric film is formed of polyvinylidene fluoride.

4. The film speaker of claim 1, wherein the plurality of carbon nanotube films have a resistance value from 50 Ω/sq to 20 kΩ/sq.

5. The film speaker of claim 4, wherein the plurality of carbon nanotube films have a resistance value from 50 Ω/sq to 2 kΩ/sq.

6. The film speaker of claim 5, wherein the plurality of carbon nanotube films have a resistance value from 50 Ω/sq to 200 Ω/sq.

7. The film speaker of claim 1, wherein the carbon nanotube films are formed by one of a spraying method, a decompression filter method, a spin coating method, an electrophoresis deposition method, a casting method, an inkjet printing method, and an offset printing method.

8. The film speaker of claim 7, wherein the plurality of carbon nanotube films are made of a carbon nanotube solution in which 0.01 through 30 wt % of a carbon nanotube, 70 through 99.99 wt % of a solvent, and 0.01 through 20 wt % of a dispersing agent are mixed.

9. The film speaker of claim 8, wherein each carbon nanotube film is made of one of a single-walled carbon nanotube, a dual-walled carbon nanotube, a multi-walled carbon nanotube, and a rope carbon nanotube.

10. The film speaker of claim 8, wherein the solvent is at least one of water, methyl alcohol, ethyl alcohol, isopropyl alcohol, normal butanol, Toluene, Xylene, 1-metyl-2-pyrrolidon, chloroform, etyle acetate, 2-methoxyethanol, ethylene glycol, polyethylene glycol, and dimethyl sulfoxide.

11. The film speaker of claim 8, wherein the dispersing agent is at least one of a sodium dodecy sulfate (SDS) dispersing agent, a triton X dispersing agent, and a lithium dodecy sulfate (LDS) dispersing agent.
